(19) United States
(12) Patent Application Publication
(10) Pub. No.: US 2023/0092464 A1
(43) Pub. Date: Mar. 23, 2023

(54) SWITCH MODULE

(71) Applicant: KABUSHIKI KAISHA TOKAI RIKA DENKI SEISAKUSHO, Aichi (JP)

(72) Inventors: Masahiro KATO, Aichi (JP); Nobuyuki ISHIGURE, Aichi (JP); Yuki SATO, Aichi (JP)

(21) Appl. No.: 17/795,457

(22) PCT Filed: Jan. 20, 2021
(86) PCT No.: PCT/JP2021/001898

§ 371 Date: Jul. 26, 2022

(30) Foreign Application Priority Data
Jan. 28, 2020 (JP) 2020-011429

(51) Int. Cl. B62D 1/04; F16H 59/04; G05G 1/01

(52) U.S. Cl. CPC B62D 1/046; F16H 59/044; G05G 1/01

(57) ABSTRACT

A switch module includes a lever switch to operate at least one electronic device mounted on a vehicle by an operation on an operation lever, and a case that is integrated with the lever switch installed thereto and is installed to a back side of a steering of the vehicle so as to integrally rotate with the steering. The case is box-shaped with a front surface portion open, and the lever switch is installed by sliding from the front surface portion toward a back surface portion into an installation opening that is formed on a side surface of the case and has a cut-out shape extending the front surface portion toward the back surface portion.

### CROSS-REFERENCES TO RELATED APPLICATIONS

The present patent application claims the priority of Japanese patent application No. 2020/011429 filed on Jan. 28, 2020, and the entire contents of Japanese patent application No. 2020/011429 are hereby incorporated by reference.

### TECHNICAL FIELD

The present invention relates to a switch module.

### BACKGROUND ART

A lever switch device for vehicle is known which can operate electronic devices such as a direction indicator or wiper device by an operation lever (see, e.g., Patent Literature 1).

The lever switch device for vehicle is installed to a steering column on left and right when viewed from a user so that the user can operate them while gripping a steering. A column cover is installed to this steering column, and the operation levers on the left and right protrude from openings of the column cover.

### CITATION LIST

### Patent Literature

Patent Literature 1: JP 2017/168314 A

### SUMMARY OF INVENTION

### Technical Problem

The lever switch device for vehicle disclosed in Patent Literature 1 is installed to the steering column and, then, the column covers divided in the vertical direction are installed. This requires, e.g., positioning of the opening portion through which the operation lever protrudes and, hence, it takes time and effort to install.

It is an object of the invention to provide a switch module that can be easily installed.

### Solution to Problem

According to an embodiment of the invention, a switch module comprises:
a lever switch that can operate at least one electronic device mounted on a vehicle; and
a case that is integrated with the lever switch installed thereto and is installed to a back side of a steering of the vehicle so as to integrally rotate with the steering.

### Advantageous Effects of Invention

According to an embodiment of the invention, a switch module can be provided that is easily installed.

### BRIEF DESCRIPTION OF DRAWINGS

FIG. 1 is an explanatory diagram illustrating the interior of a vehicle in which a switch module in an embodiment is arranged.

FIG. 2 is an explanatory diagram illustrating an installation direction of the switch module in the embodiment.

FIG. 3 is an explanatory diagram illustrating flows of main signals of the switch module and installation of a lever switch in the embodiment.

FIG. 4 is an exploded perspective view showing the switch module in the embodiment.

### DESCRIPTION OF EMBODIMENTS

### Summary of the Embodiments

A switch module in the embodiment has a lever switch that can operate at least one electronic device mounted on a vehicle, and a case that is integrated with the lever switch installed thereto and is installed to a back side of a steering of the vehicle so as to integrally rotate with the steering.

The lever switch is integrated with the case and the case is further installed to the steering. Therefore, the switch module can be easily installed as compared to the case where the lever switch is installed to the steering column.

### EMBODIMENT

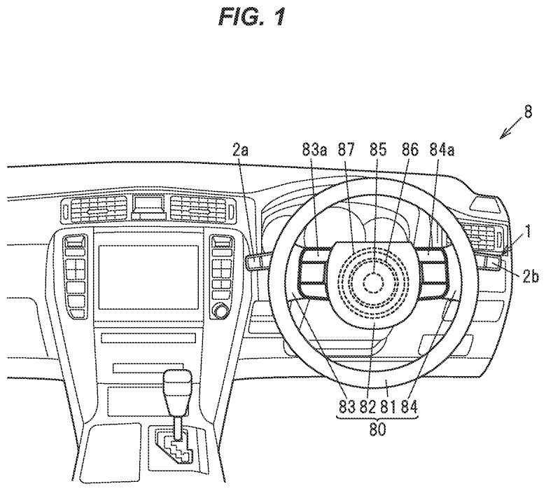

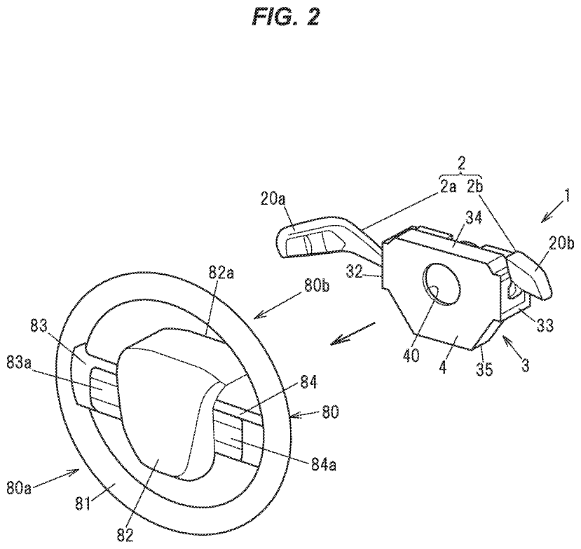

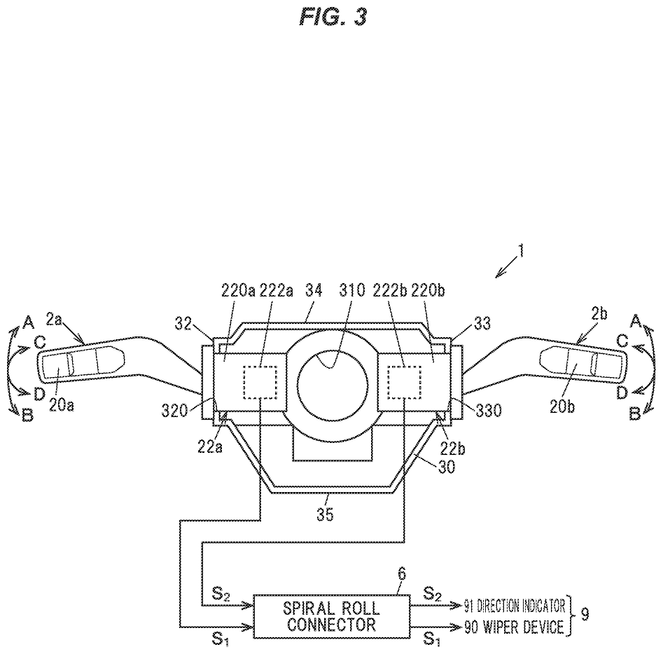

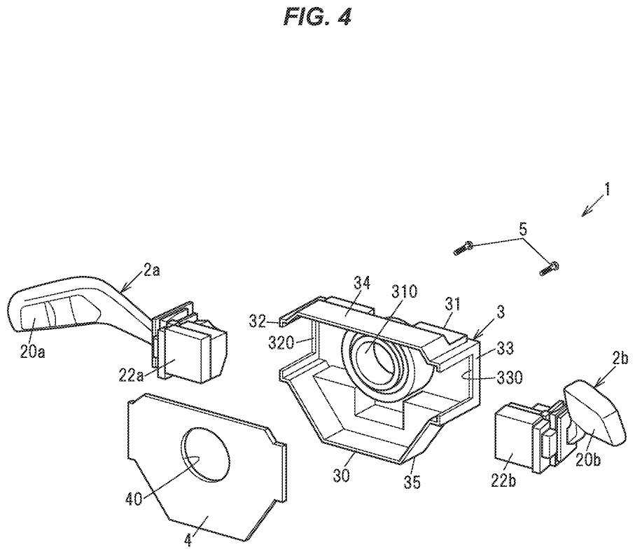

(General configuration of a switch module 1) FIG. 1 is an explanatory diagram illustrating the interior of a vehicle. FIG. 2 is an explanatory diagram illustrating installation of the switch module. FIG. 3 is an explanatory diagram illustrating flows of signals of the switch module. FIG. 4 is a perspective view showing the switch module.

In each drawing of the embodiment described below, a scale ratio or shape may be different from an actual ratio or shape. In addition, in FIG. 3, the flows of main signals are indicated by arrows. In addition, in the following description, upward/downward refers to upward/downward based on a user sitting in a driver's seat of a vehicle 8, i.e., upward/downward of the vehicle 8, and left/right refers to left/right based on the user, i.e., left/right of the vehicle 8. Furthermore, forward/rearward refers to forward/rearward based on the user, i.e., forward/rearward of the vehicle 8.

As shown in FIG. 1, the switch module 1 is attached to a steering 80 of the vehicle 8. The steering 80 includes a steering wheel 81 gripped by a user, a horn pad portion 82 which is connected to a steering shaft 85 and to which an alerting device and an airbag, etc., are installed, and left and right spoke portions 83 and 84 which connect the steering wheel 81 to the horn pad portion 82.

As shown in FIG. 2, a steering switch 83a and a steering switch 84a, which can operate electrically-connected devices, are arranged on the spoke portion 83 and the spoke portion 84 on a front side 80a of the steering 80. The steering switch 83a and the steering switch 84a are composed of plural push switches, as an example.

The steering 80 is a circular steering with the circular steering wheel 81, but may be an irregular-shaped steering with a shape other than a circle. In addition, the steering 80 is rotatable at a small rotational angle, as an example. The rotational angle of the steering 80 is not more than 90° in the clockwise direction and the counter-clockwise direction on the paper surface of FIG. 1, as an example.

As shown in FIG. 2, the switch module 1 includes a lever switch 2 that can operate at least one electronic device mounted on the vehicle 8, and a case 3 that is integrated with the lever switch 2 installed thereto and is installed to a back side 80b of the steering 80 of the vehicle 8 so as to integrally rotate with the steering 80.

As shown in FIG. 2, the lever switch 2 in the present embodiment includes a first lever switch 2a that can operate at least one electronic device as a first operation target, and a second lever switch 2b that can operate at least one electronic device, which is different from the first operation target, as a second operation target. As a modification, the lever switch 2 may include one lever switch or may include not less than three lever switches.

In the present embodiment, the first operation target as an electronic device 9 operated by the first lever switch 2a is a wiper device 90, as shown in FIG. 3. The second operation target as the electronic device 9 operated by the second lever switch 2b is a direction indicator 91. Meanwhile, the first lever switch 2a and the second lever switch 2b may operate other electronic devices, or one lever switch may operate plural electronic devices.

As a modification, the lever switch 2 may be a lever switch to operate a paddle switch as the electronic device 9 to shift a gear position of a transmission, or a cruise control device as the electronic device 9. In the case of the paddle switch, the left lever switch is a paddle switch to downshift a gear, and the right lever switch is a paddle switch to upshift a gear.

As another modification, the lever switch 2 may include more than two lever switches. As an example, the lever switch 2 may include lever switches to respectively operate the wiper device 90, the direction indicator 91, two paddle switches and the cruise control device as the electronic devices 9.

As shown in FIG. 3, the first lever switch 2a and the second lever switch 2b of the switch module 1 are electrically connected to the electronic devices 9 through a spiral roll connector 6. The spiral roll connector 6 unwinds and rewinds a harness according to rotation of the steering 80. The spiral roll connector 6 is attached to a steering column 86 and is covered with a column cover 87.

(Configuration of the lever switch 2) As shown in FIG. 3, the first lever switch 2a of the lever switch 2 includes an operation lever 20a and a mechanical unit 22a. Likewise, the second lever switch 2b of the lever switch 2 includes an operation lever 20h and a mechanical unit 22h.

As shown in FIG. 3, the lever switch 2 is arranged so that at least the mechanical units (=the mechanical unit 22a and the mechanical unit 22b) including substrates and switches to detect an operation performed on the operation levers are not covered with a cover and are exposed in the case 3.

The mechanical unit 22a and the mechanical unit 22b are thus far installed to an installed object in the state in which they are covered with a cover. However, since the first lever switch 2a, and the second lever switch 2b are installed to the case 3, in the switch module 1 of the present embodiment no separate cover is needed.

As shown in FIG. 3, the operation lever 20a and the operation lever 20b can be operated upward, downward, forward and rearward when viewed from the user, i.e., in an arrow A direction, an arrow B direction, an arrow C direction and an arrow D direction. As a modification, a toggle switch, a touch sensor and a push switch may be arranged on the operation lever 20a and the operation lever 20b. As another modification, the operation lever 20a and the operation lever 20b may be configured so that tip portions thereof rotate.

The mechanical unit 22a and the mechanical unit 22b support upward, downward, forward and rearward operations of the operation lever 20a and the operation lever 20b and also detect upward, downward, forward and rearward operations, etc., of the operation lever 20a and the operation lever 20b.

As shown in FIG. 3, the mechanical unit 22a includes a substrate 220a and a switch 222a. Likewise, the mechanical unit 22b includes a substrate 220b and a switch 222b. The switch 222a and the switch 222b are composed of plural switches that are arranged on the substrate 220a and the substrate 220b and detect upward, downward, forward and rearward operations of the operation lever 20a and the operation lever 20b. The switch 222a and the switch 222b output a switch signal S1 and a switch signal 52 corresponding to the detected operation to the electronic devices 9 through the spiral roll connector 6.

(Configuration of the case 3) The case 3 is formed using, e.g., a resin material. As shown in FIG. 4, the case 3 has a box shape with a front surface portion 30 open. A case cover 4 formed using a resin material is installed to the surface portion 30 using plural screws 5. The case 3 with the case cover 4 installed thereto is installed to a back surface 82a of the horn pad portion 82 of the steering 80. Meanwhile, the case 3 without the case cover 4 may be installed to steering 80.

The case 3 is a design component that forms a design on the back side 80b of the steering 80. That is, the case 3 serves as a steering lower cover which is a design component of the steering 80, and is configured such that a back surface portion 31, a left-side surface portion 32, a right-side surface portion 33, an upper surface portion 34 and a lower surface portion 35 are exposed on the back side 80b of the steering 80 and form a design of the back side 80b of the steering 80. Therefore, a component covering the case 3, such as a cover, is not installed on the back side 80h of the steering 80.

An installation opening 320 having a cut-out shape extending the front surface portion 30 toward the back surface portion 31 is formed on the left-side surface portion 32 of the case 3. The first lever switch 2a is slid into the installation opening 320 from the front surface portion 30 toward the back surface portion 31 and is thereby installed.

An installation opening 330 having a cut-out shape extending the front surface portion 30 toward the back surface portion 31 is formed on the right-side surface portion 33 of the case 3. The second lever switch 2b is slid into the installation opening 330 from the front surface portion 30 toward the back surface portion 31 and is thereby installed.

An insertion opening 310 having a circular outer shape is provided on the back surface portion 31. Meanwhile, an insertion opening 40 is provided on the case cover 4 so as to face the insertion opening 310. The steering shaft 85 is inserted into the insertion opening 310 and the insertion opening 40. Then, an end of the steering shaft 85 which passes through the insertion opening 310 and the insertion opening 40 is connected to the steering 80. Since the the case 3 and the case cover 4 rotate together with the steering 80, the steering shaft 85 rotates in the insertion opening 310 and the insertion opening 40.

(Installation direction) The switch module 1 is installed to the steering 80 in an installation direction indicated by an arrow shown in FIG. 2, In particular, the case cover 4 is brought into contact with the back surface 82a of the horn pad portion 82 on the back side 80b of the steering 80 and the switch module 1 is installed by screws, etc.

Next, the steering shaft 85 protruding from the already-installed column cover 87 is inserted, through the insertion opening 310 and the insertion opening 40 of the switch module 1, into the steering 80 to which the switch module 1 is installed. The screw, etc., are fastened to the end of the steering shaft 85 which protrudes into the horn pad portion 82 due to this insertion, and the steering shaft 85 is thereby installed to the steering 80. Due to this fastening on the steering 80 to which the switch module 1 is installed, the steering 80 and the switch module 1 rotate integrally with the steering shall 85.

(Effects of the embodiment) The switch module 1 in the present embodiment is easily installed. In particular, since the lever switch 2 is integrated with the case 3 in the switch module 1 and the case 3 with the lever switch 2 installed thereto is further installed to the steering 80, the column cover 87 does not need to be installed while alignment of the positions of the operation levers of the lever switch 2. Therefore, the switch module 1 is easily installed as compared to when column cover is installed after the lever switch is installed to the steering column. In addition, since the lever switch 2 and the case 3 are integrated and then installed to the steering 80, the switch module 1 requires less components to be installed and the number of components and installation man-hours can be reduced as compared to when the lever switch is installed to the steering column.

Since the first lever switch 2a and the second lever switch 2b as the lever switch 2 are integrated with the case 3, the switch module 1 requires less components to be installed and the number of components and installation man-hours can be reduced as compared to when plural lever switches are separately installed to the steering column, etc.

The operation target of the first lever switch 2a is at least the wiper device 90 and the operation target of the second lever switch 2h is at least the direction indicator 91. In this case, it is not necessary to increase the length of the operation levers to locate them close to the user and it is thus easy to reduce the size of the switch module 1, as compared to when the lever switch is arranged on the steering column. Here, in case that the allowable rotation angle of the steering 80 is small, the user does not need to move the hand positions when operating the steering 80. Therefore, it is easier to operate the switch module 1 when the lever switch 2 rotates together with the steering 80 than when not rotating together.

The operation levers of the switch module 1 are close to the user, Therefore, upward/downward and forward/rearward strokes of the operation levers can be shorter strokes and operability is good as compared to when the lever switch is arranged on the steering column.

The case 3 of the switch module 1 is a design component. Therefore, a design component to cover the case 3 is not required and the number of components and installation man-hours can be reduced as compared to when a design component is installed on the back side of the steering,

The switch module 1 is configured such that the lever switch 2 is installed to the case 3. Therefore, the number of components can be reduced as compared to when a cover is provided for each lever switch.

The lever switch 2 is integrated with the case 3, and the steering 80 and the switch module 1 are further integrated. Therefore, it is easy to reduce the size of the switch module 1 as compared to when the lever switch is installed to the steering column.

Since the switch module 1 can be reduced in size, the steering wheel 81 can be reduced in size. Therefore, the switch module 1, together with the steering wheel 81, is less likely to come into contact with the user when, e.g., the steering 80 rotates by automated driving, not by user's operation.

Although some embodiment and modifications of the invention have been described, these embodiment and modifications are merely examples and the invention according to claims is not to be limited thereto. These new embodiment and modifications thereof may be implemented in various other forms, and various omissions, substitutions and changes, etc., can be made without departing from the gist of the invention. In addition, not all combinations of the features described in these embodiment and modifications are necessary to solve the problem of the invention. Further, these embodiment and modifications thereof are included within the scope and gist of the invention and also within the invention described in the claims and the range of equivalency.

### REFERENCE SIGNS LIST

1 SWITCH MODULE
2 LEVER SWITCH
2a FIRST LEVER SWITCH
2b SECOND LEVER SWITCH
3 CASE
8 VEHICLE
9 ELECTRONIC DEVICE
20a, 20b OPERATION LEVER
22a, 22b MECHANICAL UNIT
30 FRONT SURFACE PORTION
31 BACK SURFACE PORTION
32 LEFT-SIDE SURFACE PORTION
33 RIGHT-SIDE SURFACE PORTION
34 UPPER SURFACE PORTION
35 LOWER SURFACE PORTION
80b BACK SIDE
81 STEERING WHEEL
90 WIPER DEVICE
91 DIRECTION INDICATOR
220a, 220b SUBSTRATE
222a, 222b SWITCH
320, 330 INSTALLATION OPENING

1. A switch module, comprising:
a lever switch to operate at least one electronic device mounted on a vehicle by an operation on an operation lever; and
a case that is integrated with the lever switch installed thereto and is installed to a back side of a steering of the vehicle so as to integrally rotate with the steering.

2. The switch module according to claim 1, wherein the lever switch is arranged so that at least a mechanical unit comprising a substrate and a switch to detect an operation performed on the operation lever is not covered with a cover and is exposed in the case.

3. The switch module according to claim 1 or 2, wherein the case has a box shape with a front surface portion open, and wherein the lever switch is configured to be installed by sliding from the front surface portion toward a back surface portion into an installation opening that is formed on a side surface of the case and has a cut-out shape extending the front surface portion toward the back surface portion.

4. The switch module according to claim 1, wherein the case comprises a design component that forms a design on the back side of the steering.

5. The switch module according to claim 1, wherein the operation lever is operated in upward, downward, forward and rearward directions when viewed from a user.

6. The switch module according to claim 1, wherein at least one selected from a toggle switch, a touch sensor and a push switch is arranged on the operation lever.

7. The switch module according to claim 1, wherein the operation lever is configured so that a tip portion thereof rotates.

8. The switch module according to claim 1, wherein the lever switch comprises a first lever switch that can operate at least one electronic device as a first operation target, and a second lever switch that can operate at least one electronic device, which is different from the first operation target, as a second operation target.

9. The switch module according to claim 8, wherein the first operation target as an electronic device operated by the first lever switch comprises a wiper device, and wherein the second operation target as an electronic device operated by the second lever switch comprises a direction indicator.

10. The switch module according to claim 8, wherein the first operation target as an electronic device operated by the first lever switch comprises a paddle switch that is one of paddle switches to shift a gear position of a transmission and is to downshift a gear, and wherein the second operation target as an electronic device operated by the second lever switch comprises a paddle switch that is one of the paddle switches to shift the position of the transmission and is to upshift a gear.
